(19) United States
(12) Patent Application Publication
(10) Pub. No.: US 2026/0282195 A1
(43) Pub. Date: Sep. 17, 2026

(54) LIGHT FIXTURE WITH DYNAMICALLY SWITCHABLE BEAM ANGLE

(71) Applicant: Solais Lighting, LLC, Frisco, TX (US)

(72) Inventors: Daniel Miller, Dallas, TX (US); Oscar Romero, Wylie, TX (US)

(73) Assignee: Solais Lighting, LLC, Frisco, TX (US)

(21) Appl. No.: 19/367,960

(22) Filed: Oct. 24, 2025

Related U.S. Application Data
(60) Provisional application No. 63/771,988, filed on Mar. 14, 2025.

(51) Int. Cl. H05B 47/17; F21V 23/00

(52) U.S. Cl. CPC H05B 47/17; F21V 23/003

(57) ABSTRACT

Provided herein are aspects and embodiments related to light fixtures having dynamically switchable beam angles. A light fixture according to this disclosure may have an array of light emitting elements disposed in a housing and configured to emit light from groups of light emitting elements corresponding to a selected mode. Each mode may result in the output light having a different beam angle. One application of this technology may be to provide lighting suitable for a variety of environments.

### CROSS REFERENCE TO RELATED APPLICATION

This application claims the benefit under 35 U.S.C. § 119(e) of U.S. Provisional Application No. 63/771,988, filed Mar. 14, 2025, titled “LIGHT FIXTURE WITH DYNAMICALLY SWITCHABLE BEAM ANGLE,” the entire contents of which are incorporated by reference herein.

### BACKGROUND

Light fixtures are used in commercial, residential, and/or industrial settings. Light fixtures emit light to enhance the visibility, emphasis, and/or mood of areas being lit. A light fixture may have a beam angle, also referred to as “angle of divergence,” corresponding to the degree which emitted light spreads out upon emission from the light fixture.

### BRIEF SUMMARY

In some aspects, the techniques described herein relate to a light fixture configured to control angular divergence of emission, the light fixture including: a housing; an array of light emitting elements disposed in the housing and configured to emit light; an optical element coupled to the housing and configured to output the light emitted by the array outside of the housing; and circuitry configured to: generate a signal representing selection of a mode from among first, second, and third modes; and control the array of light emitting elements based on the signal such that the light, upon being output outside the housing, has: a first beam angle when the first mode is selected, a second beam angle when the second mode is selected, the second beam angle being greater than the first beam angle, and a third beam angle when the third mode is selected, the third beam angle being greater than the second beam angle, wherein controlling the array includes: causing a first group of light emitting elements to emit the light when the first mode is selected; causing a second group of light emitting elements to emit the light when the second mode is selected; and causing a third group of light emitting elements to emit the light when the third mode is selected.

In some embodiments, the light emitting elements of the first group define a first substantially circular arrangement.

In some embodiments, the light emitting elements of the second group define a second substantially circular arrangement encompassing the first substantially circular arrangement.

In some embodiments, the light emitting elements of the third group define a third substantially circular arrangement encompassing the second substantially circular arrangement.

In some embodiments, the first group of light emitting elements is a subset of the second group of light emitting elements.

In some embodiments, the second group of light emitting elements is a subset of the third group of light emitting elements.

In some embodiments, the second group has more light emitting elements than the first group, and the third group has more light emitting elements than the second group.

In some aspects, the techniques described herein relate to a light fixture, including: a housing; an array of light emitting elements disposed in the housing; circuitry, configured to: generate a signal representing selection of a mode among a plurality of selectable modes; and control the array of light emitting elements based on the signal, wherein: in at least some modes of the plurality of selectable modes, the circuitry causes a different group of light emitting elements of the array to emit light; and an optical element coupled to the housing, wherein the optical element is configured to output the light emitted by the array of light emitting elements outside the housing.

In some embodiments, the plurality of selectable modes comprises at least a first mode and a second mode and the circuitry is configured to control a first group of light emitting elements to emit the light in response to generation of the signal as representing the selection of the first mode and control a second group of light emitting elements to emit the light in response to generation of the signal as representing the selection of the second mode. The second group comprises more light emitting elements than the first group.

In some embodiments, the first group is a subset of the second group.

In some embodiments, the light emitting elements that are included in the second group and are excluded from the first group encircle the light emitting elements that are included in the first group.

In some embodiments, the plurality of selectable modes further comprises a third mode the circuitry is further configured to control a third group of light emitting elements to emit the light in response to generation of the signal as representing the selection of the third mode. The third group comprises more light emitting elements than the second group.

In some embodiments, the second group is a subset of the third group.

In some embodiments, the optical element is configured such that the light emitted by the array of light emitting elements has, upon being output outside the housing: a first beam angle when the first mode is selected, and a second beam angle when the second mode is selected. The second beam angle is greater than the first beam angle.

In some embodiments, the array comprises a first plurality of light emitting elements electrically connected in series and a second plurality of light emitting elements electrically connected in series. The first group comprises the first plurality of light emitting elements and the second group comprises the first plurality of light emitting elements and the second plurality of light emitting elements.

In some embodiments, the optical element comprises a reflective portion configured to reflect the light emitted by the array and a refractive portion configured to output the reflected light outside the housing.

In some embodiments, the reflective portion is configured to reflect the light via total internal reflection In some embodiments, the reflective portion comprises a conical shape.

In some embodiments, the refractive portion is configured to direct the reflected light towards a principal axis of the refractive portion.

In some embodiments, the array is disposed approximately at a distance from the refractive portion corresponding to a focal length of the refractive portion

In some embodiments, the optical element further comprises a cavity opposite the refractive portion, and the array is at least partially aligned with the cavity.

In some embodiments, the array of light emitting elements are disposed on a same circuit board.

In some embodiments, the circuitry comprises an actuator configured to generate the signal responsive to user input.

In some embodiments, the circuitry comprises a wireless transceiver configured to generate the signal responsive to reception of a wireless signal.

In some aspects, the techniques described herein relate to a light fixture, including: a housing; an array of light emitting elements disposed in the housing, the array including: a first plurality of light emitting elements electrically coupled in series with one another; and a second plurality of light emitting elements electrically coupled in series with one another; one or more switches, disposed in the housing, configured to cause the array to emit light at least in part by: in a first state, causing current flow through the first plurality of light emitting elements and blocking current flow through the second plurality of light emitting elements, and in a second state, causing current flow through the first plurality of light emitting elements and the second plurality of light emitting elements; and an optical element coupled to in the housing, wherein the optical element is configured to output the light emitted by the array of light emitting elements outside the housing.

In some embodiments, the light fixture further comprises a third plurality of light emitting elements electrically connected in series with one another. The one or more switches are further configured to cause the array to emit light at least in part by: in a third state, causing current flow through the first plurality of light emitting elements, the second plurality of light emitting elements and the third plurality of light emitting elements.

In some embodiments, the switches are further configured to: in the first state, block current flow through the third plurality of light emitting elements, and in the second state, block current flow through the third plurality of light emitting elements.

In some embodiments, the optical element is configured to: output the light emitted by the array with a first beam angle when the one or more switches are in the first state; and output the light emitted by the array with a second beam angle when the one or more switches are in the second state. The second beam angle is greater than the first beam angle.

In some aspects, the techniques described herein relate to a method for controlling a light fixture including a housing, an array of light emitting elements disposed in the housing and a optical element coupled to the housing, the method including: causing mode selection circuitry to generate a signal representing selection of a mode among a plurality of selectable modes; and controlling the array of light emitting elements to emit light through the optical element based on the signal generated by the mode selection circuitry, wherein: controlling the array includes causing a different group of light emitting elements of the array to emit the light based on the selection of the mode, and the light fixture outputs the light outside the housing with a different beam angle based on the selection of the mode.

In some embodiments, controlling the array comprises controlling one or more switches to: in a first state, cause current flow through a first plurality of light emitting elements and block current flow through a second plurality of light emitting elements, and in a second state, cause current flow through the first plurality of light emitting elements and the second plurality of light emitting elements.

The foregoing summary is provided by way of illustration and is not intended to be limiting.

### BRIEF DESCRIPTION OF DRAWINGS

Various aspects and embodiments will be described with reference to the following figures. It should be appreciated that the figures are not necessarily drawn to scale.

FIG. 1 is a perspective view of a light fixture having dynamically switchable beam angles, according to some embodiments of the present disclosure.

FIG. 2 is a block diagram of a light fixture having dynamically switchable beam angles, according to some embodiments of the present disclosure.

FIG. 3 is a schematic diagram illustrating the correspondence of selected modes, groups of light emitting elements, and beam angle of a light fixture, according to some embodiments of the present disclosure.

FIG. 4 is an illustration of a light fixture operating in different modes corresponding to different beam angles, according to some embodiments of the present disclosure.

FIG. 5A is a perspective view of a light emitting element array, according to some embodiments of the present disclosure.

FIG. 5B is an illustration of the light emitting element array of FIG. 5A arranged into groups, according to some embodiments of the present disclosure.

FIG. 6 is a perspective view of a partially-disassembled light fixture having dynamically switchable beam angles, according to some embodiments of the present disclosure.

FIG. 7 is a perspective view of a lens such as may be used in a light fixture having dynamically switchable beam angles, according to some embodiments of the present disclosure.

FIG. 8A is a diagram illustrating the path of rays of light from a first light emitting element through a lens such as may be used in a light fixture having dynamically switchable beam angles, according to some embodiments of the present disclosure.

FIG. 8B is a diagram illustrating the path of rays of light from second and third light emitting elements through the lens of FIG. 8A, according to some embodiments of the present disclosure.

FIG. 9 is a diagram illustrating circuitry of a light fixture having dynamically switchable beam angles, according to some embodiments of the present disclosure.

### DETAILED DESCRIPTION

Described herein are light fixtures emitting beams having beam angles which are electronically controllable. The inventors have recognized and appreciated that the ability to electronically control the beam angle allows installers to easily adapt a light fixture to environments having different lighting requirements. For example, the lighting requirements for a retail store-such as intensity and diffuseness-may differ significantly from those of a restaurant or hotel lobby. Additionally, factors like ceiling height and natural light exposure can greatly influence the ideal lighting characteristics for a given space. Yet, installers may have limited knowledge of the environment, or the customer's preferences, until they arrive on-site.

Light fixtures which allow for dynamic adjustment of the beam angle may be beneficial in these circumstances. Upon arriving at the site, the installer may adjust the beam angle of light emitted by a light fixture until the desired lighting effect is achieved. Adjustment of the beam angle can be performed on-site by the installer electronically, without having to resort to complex equipment. Accordingly, techniques disclosed herein provide for light fixtures having an array of light emitting elements (e.g., light emitting diodes or “LEDs”) disposed in a housing, an optical element (e.g., a lens or a reflector) coupled to the housing and configured to output the light emitted by the array outside the housing, and circuitry configured to operate the light fixture in different modes corresponding to desired beam angles. In some embodiments, the desired beam angle may be set on the basis of which light emitting elements of an array are activated. For example, controlling the array to activate a first group of light emitting elements may cause the light fixture to emit light with a first beam angle while controlling the array to activate a second group of light emitting elements may cause the light fixture to emit light with a second beam angle. In some embodiments, the second beam angle is greater than the first beam angle if activating the second group results in a greater emission area than activating the first group does. The emission area indicates that region of an array of light emitting elements from which light is emitted.

Further description of various aspects and embodiments of the design and operation of light fixtures with dynamically switchable beam angles is provided below. It should be appreciated that various aspects described herein may be implemented in any of numerous ways. Examples of specific implementations are provided herein for illustrative purposes only. In addition, the various aspects and embodiments below may be used alone or in any combination and are not limited to the combinations explicitly described herein.

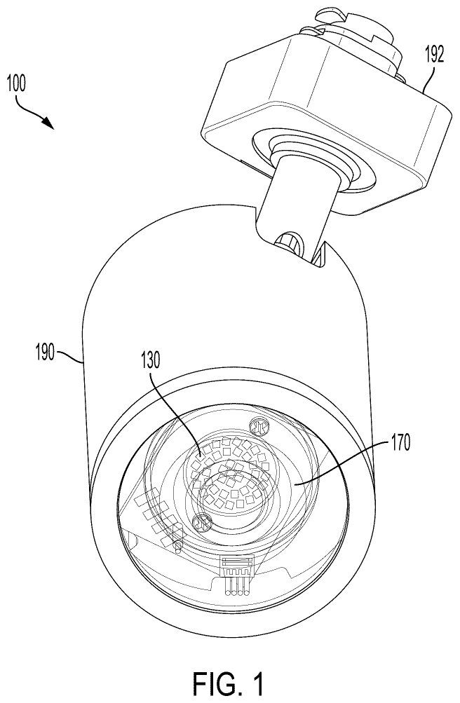

FIG. 1 is a perspective view of a light fixture 100 having dynamically switchable beam angles, according to some embodiments of the present disclosure. As shown, the light fixture 100 includes a light emitting element array 130, a lens 170, a housing 190, and a mount 192.

The housing 190 may house components of the light fixture 100 such as the light emitting element array 130 and the lens 170. Thus, the housing 190 may protect interior components from dust, water, and/or impact, for example. Additionally, the housing 190 may align interior components and prevent relative movement of components in the event of vibration such as may result from wind and/or impact, for example.

Lens 170 is coupled to housing 190. For example, lens 170 may be secured to an inner portion or an outer portion of the housing. The housing 190 may have features that secure components coupled to the housing 190. For example, the housing 190 may have threaded portions configured to allow the lens 170 to be removably coupled to the housing 190.

The housing 190 may be made of any suitable material such as may be chosen based on cost, weight, and/or durability, for example. In some embodiments, the housing 190 may be formed of plastic and/or metal.

While as shown the housing 190 has a cylindrical shape, the housing 190 may have shape which is adapted for installation in different environments. In some embodiments, the housing 190 may be permanently or removably secured, such as via the mount 192, to a frame, ceiling, wall, track-heads and/or floor, for example.

Characteristics of components of the light fixture 100 such as the light emitting element array 130 and the lens 170 will be further described in conjunction with other figures. Components of the light fixture of a given figure may have at least some of the properties of the corresponding components described in conjunction with separate figures.

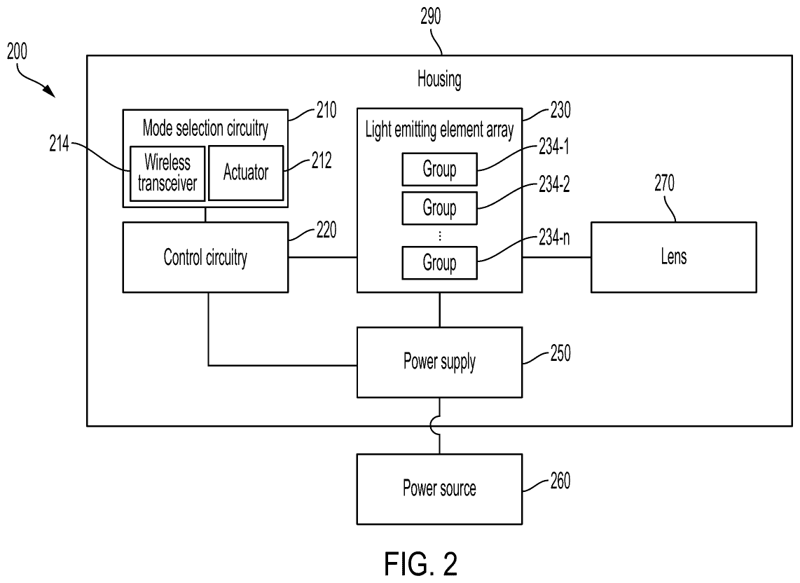

FIG. 2 is a block diagram of a light fixture 200 having dynamically switchable beam angles, according to some embodiments of the present disclosure. As shown in FIG. 2, the light fixture 200 includes circuitry including mode selection circuitry 210 and control circuitry 220, a light emitting element array 230, a power supply 250, a power source 260, a lens 270, and a housing 290.

The mode selection circuitry 210 may be configured to generate a signal representing a selection of a mode from among a plurality of selectable modes. For example, the mode selection circuitry 210 may be configured to receive an input from a user of the light fixture 200 indicating a mode to be selected. In some embodiments, the input may be provided via an actuator 212 (e.g., a mechanical actuator such as a physical button or a knob, or an electronic interface such as an electronic button or a touchscreen) and/or wirelessly via wireless transceiver 214, for example.

The wireless transceiver 214 may be configured to receive the input indicative of a selection of mode by a user via wireless communication. The wireless transceiver 214 may operate via any suitable communication protocol. For example, the wireless transceiver 214 may operate via Bluetooth®, Wi-Fi® or Internet-based communications. In some embodiments, the wireless transceiver 214 may be configured to cause the light fixture 200 to function in synchronization with other light fixtures. In such configurations, the wireless transceiver 214 may be configured to transmit signals indicative of a current mode in response to a request received from a controller of the synchronized light fixtures.

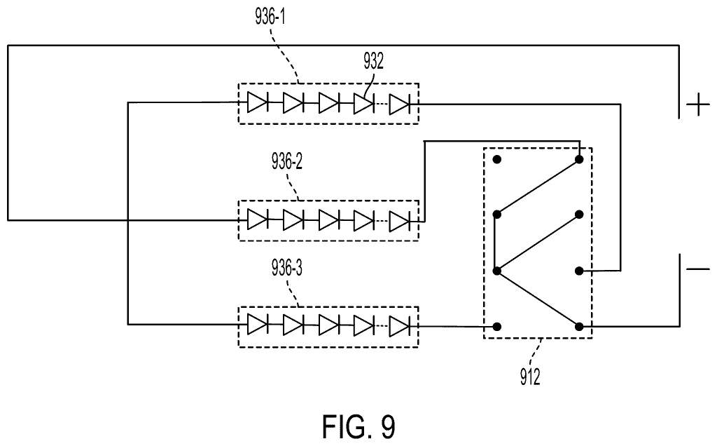

The control circuitry 220 may be configured to control the light emitting element array 230 based on the signal generated by the mode selection circuitry 210. For example, the control circuitry 220 may be configured to activate light emitting elements depending on the state of one or more switches, as described in connection with FIG. 9. The control circuitry may be coupled to the mode selection circuitry 210 and may be coupled to the light emitting element array 230. In some embodiments, the control circuitry 220 controls the light emitting element array 230 directly. For example, the control circuitry 220 may produce currents intended to selectively activate the desired group of light emitting elements. In other embodiments, the control circuitry 220 controls the light emitting element array 230 indirectly through the power supply 250. For example, the control circuitry 220 may activate one or more switches that selectively couple, depending on the state of the switch(es), sets of light emitting elements to the power supply 250. An example of this arrangement is shown in FIG. 9.

The switch(es) may be configured, in response to the signal generated by the mode selection circuitry, to turn on the elements of the light emitting element array 230 corresponding to the selected mode. For example, the switch(es) may turn on various groupings of the light emitting element array 230. In some embodiments, the switch(es) may have a plurality of states, and in a first state may turn on a first grouping of the light emitting element array 230, in a second state may turn on a second grouping of the light emitting element array 230, in a third state may turn on a third grouping of the light emitting element array 230, and so forth. The switch(es) may have a state in which no current flows through the light emitting element array 230 such that none of the light emitting elements is turned on.

Electrical power may be provided by the power supply 250, which may in turn be powered by the power source 260.

The power supply 250 may be configured to support current draw of the light emitting element array 230. In some embodiments, the power supply 250 may be configured to provide a constant voltage regardless of the mode set by the mode selection circuitry 210. In some embodiments, the power supply 250 may be disposed within the housing 290.

The power source 260 may be any source of electrical power suitable for powering the light emitting element array 230. For example, the power source may be a battery, an energy harvesting unit (e.g., a photovoltaic unit) or an alternating current or direct current power outlet. In embodiments in which the power source 260 is a battery, the power source 260 may be, but is not necessarily, disposed in the housing 290.

In some embodiments, the mode selection circuitry 210 and the control circuitry 220 may be disposed within the housing 290. For example, the mode selection circuitry 210 and the control circuitry 220 may be implemented using an electronic circuit (e.g., a processor, an application specific integrated circuit, a field programmable gate array, a controller, etc.) mounted on a printed circuit board disposed inside housing 290. However, in other embodiments the mode selection circuitry 210 and/or the control circuitry 220 may be disposed external to the housing 290.

In some embodiments, the same electrical circuit elements may perform the functions of the combination of the mode selection circuitry 210 and the control circuitry 220.

The light emitting element array 230, which may be disposed within the housing 290, may include a plurality of light emitting elements (e.g., light emitting diodes or other types of optical sources). The light emitting elements may be arranged in groups. For example, in a light fixture 200 with n groups 234, there may be group 234-1, group 234-2 ... group 234-n, as shown. In some embodiments, the number of groups 234 may correspond with the number of modes of the plurality of selectable modes and thus with the number of states of the switch(es) of control circuity 220.

In some embodiments, the groups 234 may be defined such that some elements of the light emitting element array 230 may be in multiple groups. For example, a first plurality of light emitting elements may in some embodiments be considered part of a first group 234-1, a second group 234-2, and a third group 234-3, a second plurality of light emitting elements may be part of the second group 234-2 and the third group 234-2, and a third plurality of light emitting elements may only be part of the third group 234-3.

However, in some embodiments, the groups 234 may be defined such that elements of the light emitting element array 230 are in a single group 234 and may not be in multiple groups. For example, a first plurality of light emitting elements may be part of the first group 234-1, a second plurality of light emitting elements may be part of the second group 234-2, and a third plurality of light emitting elements may be part of the third group 234-3.

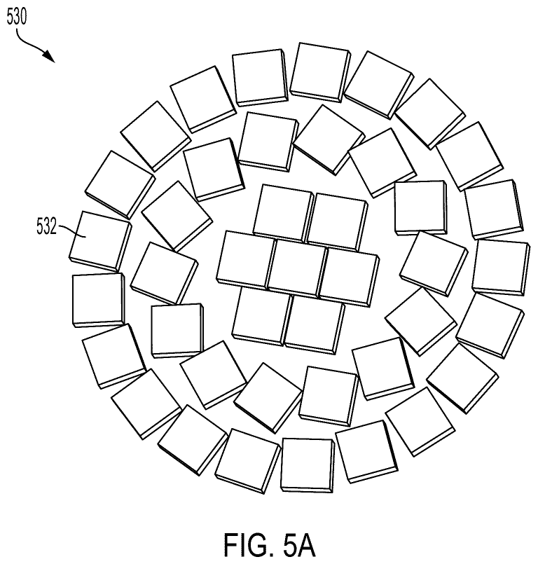

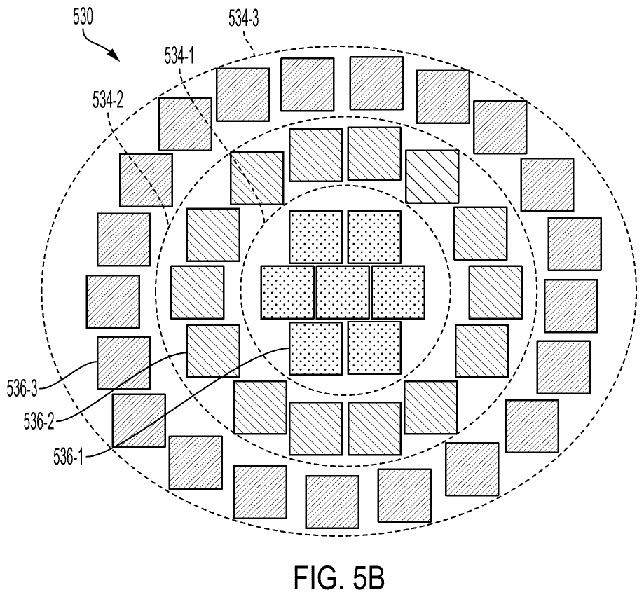

The groups 234 are further described in conjunction with other figures such as FIG. 5B.

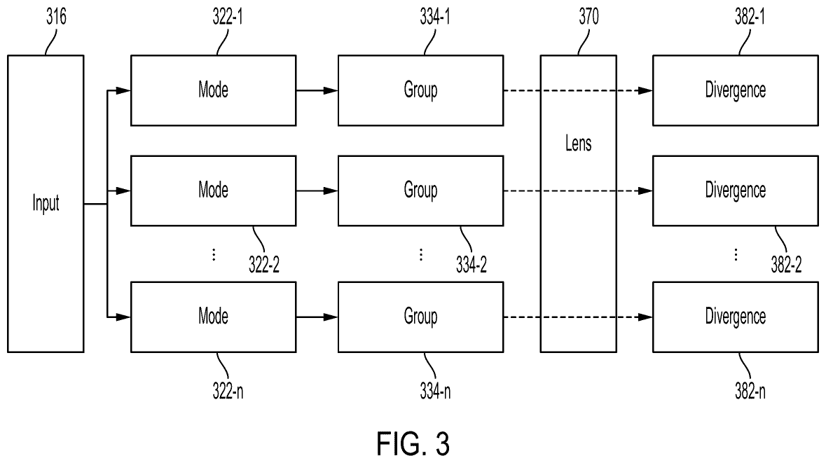

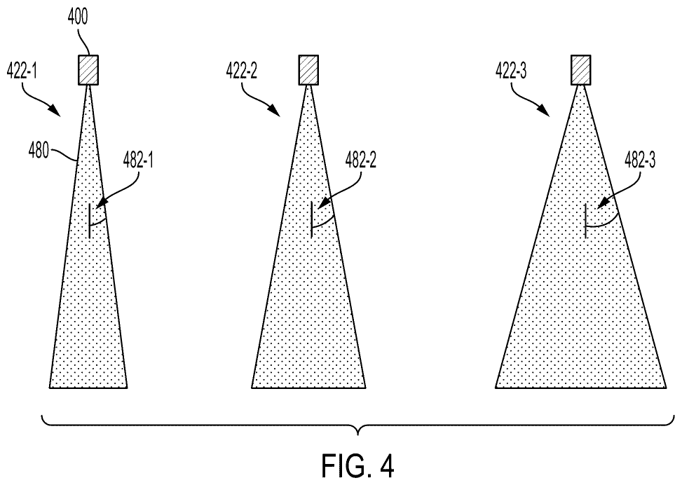

The lens 270 may be configured to output light emitted by the light emitting element array 230 outside housing 290. For example, lens 270 may output light emitted by the group 234 emitting light due to function of the control circuitry 220. In some embodiments, the lens 270 may be a total internal reflection (TIR) lens. Light output from the lens 270 may have a beam angle corresponding to the mode selected by the mode selection circuitry 210 and thus to the group 234 of active light emitting elements, as is further described in conjunction with other figures such as FIGS. 3-4 .

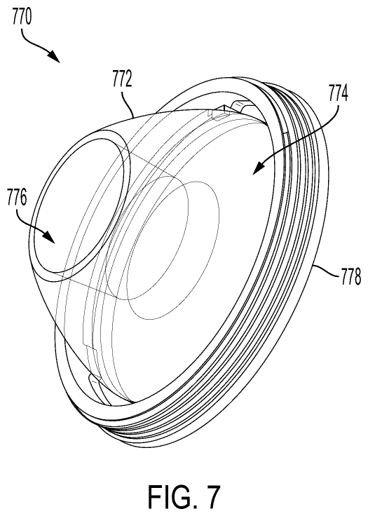

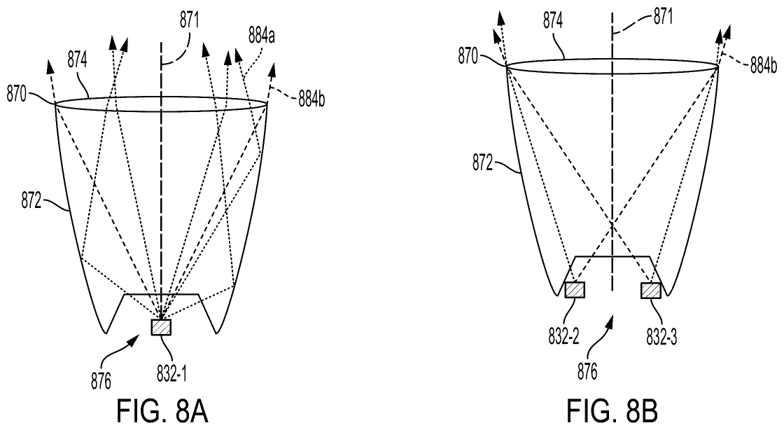

FIG. 3 is a schematic diagram illustrating the correspondence of selected modes 322, groups 334 of light emitting elements, and beam angle 382 of a light fixture, according to some embodiments of the present disclosure. As can be seen and as is described in conjunction with other figures, an input 316—for example, such as may be provided by a user via mode selection circuitry-may allow the selection of a mode 322-1 out of a plurality of modes 322-1, 322-2, ... 322-n. Each mode 322 may correspond to a group 334 of light emitting elements which are active-for example, experiencing a current therethrough and emitting light-during operation of the light fixture in the selected mode 322. The group 334 may emit light which passes through a lens 370, thereafter exiting the light fixture with a certain beam angle 382 resulting for example from the physical positioning of the group 334 and the operation of the lens 370. The impact of physical positioning of the group 334 and of the operation of the lens 370 is further described in conjunction with other figures such as FIGS. 7-8B.

In the figure, mode 322-1 corresponds to group 334-1, which corresponds to beam angle 382-1, mode 322-2 corresponds to group 334-2 which corresponds to beam angle 382-2, and mode 322-n corresponds to group 334-n which corresponds to beam angle 382-n.

FIG. 4 is an illustration of a light fixture 400 operating in different modes 422 corresponding to different beam angles 482, according to some embodiments of the present disclosure.

As can be seen, different modes 422 may correspond to different beam angles 482 (e.g., such beam angles 482 determining at least in part a divergence of the light fixture 400). For example, the light fixture 400 may operate in a first mode 422-1 in which the light fixture 400 emits an output beam 480 having a first beam angle 482-1. The light fixture 400 may also operate in a second mode 422-2, outputting the beam 480 with a second beam angle 482-2 which is greater than the first beam angle 482-1. The light fixture 400 may further operate in a third mode 422-3, outputting the beam 480 with a third beam angle 482-3 which is greater than the second beam angle 482-2.

In some embodiments, the first beam angle 482-1 may be between 15 degrees and 30 degrees, the second beam angle 482-2 may be between 20 degrees and 40 degrees, and the third beam angle 482-3 may be between 30 degrees and 50 degrees. However, the beam angles 482 may be any suitable angles. Accordingly, the beam angles 482 may be separated by a larger or smaller number of degrees from one mode to another, and the separation between modes may not be constant. For example, the first beam angle 482-1 may be 5 degrees, the second beam angle 482-2 may be 10 degrees, and the third beam angle may be 25 degrees. Alternatively, the first beam angle 482-1 may be 40 degrees, the second beam angle may be 50 degrees, and the third beam angle may be 55 degrees. The beam angles 482 may range from 0 degrees to 90 degrees as the lens and the orientation of the light emitting element array may allow.

Assuming a constant distance of the light fixture 400 from a target to be lit, the different modes 422 may correspond to different beam widths—and areas lit—at the target. For example, the different modes 422 may illuminate circles of different radii. Conversely, the different modes 422 may be used to illuminate areas of the same radii with light fixtures at different distances from the target. The relationship between the beam angles 482, distance of the light fixture 400 from the target, and area to be lit by the beam 480 may be determined through trigonometric principles, for example.

In some light fixtures 400, there may be modes 422 which do not impact the beam angle 482 of the output beam 480 but which otherwise and/or additionally impact the performance of the light fixture 400. For example, there may be modes 422 which change the color and/or intensity of the beam 480 output by the light fixture 400. In some embodiments, there may be modes which change the orientation of the light fixture 400 and/or a lens such that the direction of the output beam 480 changes. There may also be modes which asymmetrically adjust the beam angle 482, for example through asymmetrical groupings of light emitting elements, such that different portions of the beam 480 have different beam angles 482.

FIG. 5A is a perspective view of a light emitting element array 530, according to some embodiments of the present disclosure.

The light emitting element array 530 includes a number of light emitting elements 532. The light emitting elements 532 may be of any composition or structure suitable for producing light in a light fixture responsive to an electrical current through the light emitting elements 532. For example, the light emitting elements 532 may be light emitting diodes (LEDs).

As can be seen, the light emitting element array 530 may be arranged in a generally circular pattern. Individual light emitting elements 532 may be askew—for example, oriented at an angular offset—from other light emitting elements 532 of the light emitting element array 530.

FIG. 5B is an illustration of the light emitting element array of FIG. 5A arranged into groups 534, according to some embodiments of the present disclosure.

Certain pluralities 536 of light emitting elements 532 are shown with distinct patterning for convenience of explanation. A first plurality 536-1 may define a generally circular shape. A second plurality 536-2 may define a generally circular shape encompassing and/or encircling the first plurality 536-1. A third plurality 536-3 may define a generally circular shape encompassing and/or encircling the second plurality 536-2. Accordingly, the light emitting element array 530 may include pluralities 536 which form generally concentric circles. Of course, arrangements of light emitting elements 532 which are not generally circular and/or which do not define concentric shapes may be used without departing from the scope of this disclosure.

The pluralities 536 of light emitting elements 532 may each include any suitable number of light emitting elements 532. In some embodiments, the first plurality 536-1 may include seven light emitting elements 532, the second plurality 536-2 may include fourteen light emitting elements 532, and the third plurality 536-3 may include twenty-one light emitting elements 532.

As shown in the figure, the light emitting element array 530 may include three groups 534-1, 534-2, and 534-3, although any other number of groupings is possible. Different groups may be associated with different modes of a light fixture containing the light emitting element array 530. A first group 534-1 may include the first plurality 536-1, a second group 534-2 may include the second plurality 536-2 and the first plurality 536-1, and a third group 534-3 may include the third plurality 536-3, the second plurality 536-2, and the first plurality 536-1. Accordingly, the first group 534-1 may be a subset of the second group 534-2, and the second group 534-2 may be a subset of the third group 534-3. Further accordingly, the second plurality 536-2 may be included in the second group 534-2 and the third group 534-3 and excluded from the first group 534-1, and the third plurality 536-3 may be included in the third group 534-3 and excluded from the first group 534-1 and the second group 534-2.

Although this figure sets forth one way of delineating groups 534 of the light emitting element array 530, as also described in conjunction with other figures such as FIG. 2 3, other delineations of groups 534 may be used. For example, there may be groups 534 defined such that the first group 534-1 includes only the first plurality 536-1, the second group 534-2 includes only the second plurality 536-2, and the third group 534-3 includes only the third plurality 536-6.

There may be embodiments having a greater number of groups than pluralities of light emitting elements. For example, there may be a group which only includes a first plurality, a group which only includes a second plurality, a group which only includes a third plurality, a group which includes the first plurality and the second plurality, a group which includes the second plurality and the third plurality, a group which includes the first plurality and the third plurality, and a group which includes the first plurality, the second plurality, and the third plurality.

In some embodiments, groups including pluralities having light emitting elements positioned a greater distance from a center of the light emitting element array-which may be aligned with a principal axis of a lens of the light fixture-may have a larger beam angle than groups including only pluralities having light emitting elements positioned closer to the center of the light emitting element array.

In some embodiments, groups including a greater number of pluralities may have a greater intensity of output light than groups including a smaller number of pluralities.

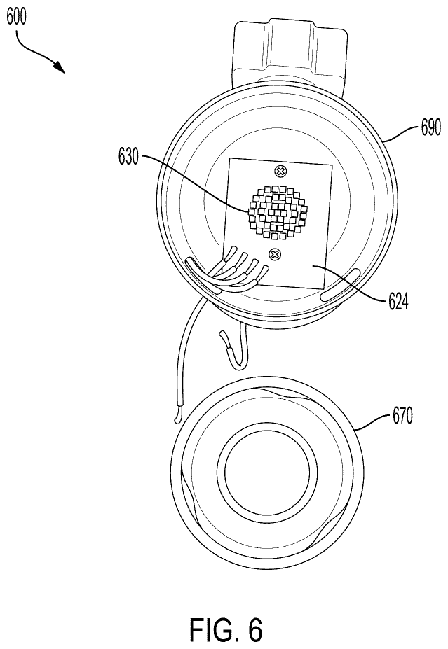

FIG. 6 is a perspective view of a partially-disassembled light fixture 600 having dynamically switchable beam angles, according to some embodiments of the present disclosure. As shown, the light emitting element array 630 may be disposed on a shared circuit board 624 such that the light emitting elements of the light emitting element array 630 are disposed in a same plane. Shown detached, a lens 670 may be removably coupled to the housing 690. For example, the lens 670 may be coupled such that a principal axis of the lens is aligned with a center of the light emitting element array 630.

FIG. 7 is a perspective view of a lens 770 such as may be used in a light fixture having dynamically switchable beam angles, according to some embodiments of the present disclosure. The lens 770 may include a reflecting portion 772, a refracting portion 774, a cavity 776, and a threaded rim 778.

The lens 770 may be coupled to a housing of the light fixture such that the reflecting portion 772 is substantially contained within the housing, the refracting portion 774 faces the exterior of the housing, the cavity 776 faces a light emitting element array, and/or the threaded rim 778 is mated with corresponding threads of the housing to secure the lens 770 to the housing.

The reflecting portion 772 of the lens 770 may reflect incident rays of light, such as may be emitted by the light emitting element array, towards the refracting portion 774. The reflecting portion 772 may be configured to reflect the incident rays of light by total internal reflection. Accordingly, the reflecting portion 772 may include a material selected for its optical refractive index to influence the critical angle determining which rays are reflected. Alternatively or additionally, the reflecting portion 772 may have a conical shape impacting an angle of incidence of incident rays of light—for example, such that a greater number of rays of light are reflected than would be absent the conical shape. The conical shape may be narrower at a side of the lens comprising the cavity 776 and broader at a side of the lens 770 comprising the refracting portion 774.

In some embodiments, the reflecting portion 772 may include a surface which reflects light by principles other than or in addition to total internal reflection. For example, the reflecting portion 772 may include a mirror.

The refracting portion 774 may be configured to output light outside the housing of the light fixture. The refracting portion 774 may direct light towards a principal axis of the refracting portion 774—this may have the effect of narrowing, focusing, and/or collimating an output beam. In some embodiments, the light emitting element array may be disposed approximately a distance from the refracting portion 774 corresponding to a focal length of the refracting portion 774.

The refracting portion 774 and the reflecting portion 772 may be formed of a same material and may be continuous with one another. In such an embodiment, the delineation between the refracting portion 774 and the reflecting portion 772 may be made by what regions of the lens 770 perform the corresponding functions of refracting exiting light and reflecting light, respectively. In alternative embodiments, the refracting portion 774 may include a material with a different optical refractive index than the reflecting portion 772.

The cavity 776 may be disposed in the lens 770 opposite the refracting portion 774. In some embodiments, the light emitting element array is at least partially aligned with—or disposed within—the cavity 776.

In some embodiments, a reflector may be used in lieu of lens 770. The reflector may be similar to lens 770, but may lack refracting portion 774. The reflector may shape the incoming light in a similar way as described in connection with lens 770, although it may operate in reflection rather than in transmission. Thus, an optical element (whether in the form of a lens or a reflector) may be used to shape and/or direct light emitted by a light emitting element array outside a housing via reflectance or transmission.

FIG. 8A is a diagram illustrating the path of rays 884 of light from a first light emitting element 832-1 through a lens 870 such as may be used in a light fixture having dynamically switchable beam angles, according to some embodiments of the present disclosure.

In the illustration of FIG. 8A, rays 884 are emitted from the first light emitting element 832-1 disposed within a cavity 876 of the lens 870. The rays 884 travel through the lens 870 before exiting through the refracting portion 874. When the rays exit the refracting portion 874, the rays 884 may be refracted such that a direction of propagation of the rays 884 is more towards a principal axis 871 of the lens 870—which, for example, passes through the midpoint of the lens 870 and is orthogonal to a plane of the lens 870—than the direction of propagation of the rays 884a was within the refracting portion 874. This may have the effect of narrowing, focusing or collimating an output beam.

The output beam may have a beam angle which is a function of the direction of propagation of the rays 884 output through the refracting portion 874. The beam angle of the output may be determined by the outermost rays 884b which have the steepest angle towards and/or away from the principal axis 871 of the lens. In some embodiments, depending for example on the configuration of the reflective portion 872, these outermost rays 884b may be rays 884 which were not reflected from the reflecting portion 872 and which exited from the refracting portion 874 at locations distal from the principal axis 871.

FIG. 8B is a diagram illustrating the path of rays 884 of light from second and third light emitting elements 832-2 and 832-3 through the lens 870 of FIG. 8A, according to some embodiments of the present disclosure.

FIG. 8B demonstrates how positioning light emitting elements 832-2 and 832-3 a distance removed from the principal axis 871 of the lens 870 may impact a direction of the outermost rays 884b and, consequently, the beam angle of a light fixture. Because light elements 832-2 and 832-3 are removed from the principal axis 871, the outermost rays 884b of light elements 832-2 and 832-3 may have a steeper angle away from the principal axis 871 than the outermost rays 884b of light emitting element 832-1.

FIG. 9 is a diagram illustrating circuitry of a light fixture having dynamically switchable beam angles, according to some embodiments of the present disclosure.

As shown, each light emitting element 932 of a plurality 936 of light emitting elements 932 may be electrically connected in series with one another. For example, a first plurality 936-1 may be electrically connected in series, a second plurality 936-2 may be electrically connected in series, and a third plurality 936-3 may be electrically connected in series. Accordingly, the light emitting elements 932 of a given plurality 936 may be configured to emit light at the same time as other light emitting elements 932 of the plurality 936.

Each plurality 962 of light emitting elements 932 may be connected to a node of a switch block 912 such that a configuration of the switch may cause and/or block current flow through the plurality 962. As described in conjunction with other figures such as FIG. 2, the switch block 912 may have one or more switches the state of which corresponds to different modes.

Each plurality 962 of light emitting elements 932 may be electrically connected on one end to other pluralities 962 of light emitting elements 932 such that the pluralities 962 may share a power supply or a common electrical ground, for example.

In some embodiments, selecting a first mode may cause only the light emitting elements of plurality 936-1 to emit; selecting a second mode may cause only the light emitting elements of pluralities 936-1 and 936-2 to emit; selecting a third mode may cause the light emitting elements of pluralities 936-1, 936-2 and 936-3 to emit.

Having thus described several aspects of at least one embodiment, it is to be appreciated that various alterations, modifications, and improvements will readily occur to those skilled in the art. Such alterations, modifications, and improvements are intended to be part of this disclosure and are intended to be within the spirit and scope of the principles described herein. Accordingly, the foregoing description and drawings are by way of example only.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” et cetera, does not by itself connote any priority, precedence, or order of one element over another or the temporal order in which acts of a method are performed. Such terms are used merely as labels to distinguish one element having a certain name from another element having a same name (but for use of the ordinal term) to distinguish the elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both,” of the elements so conjoined, e.g., elements that are conjunctively present in some cases and disjunctively present in other cases. Multiple elements listed with “and/or” should be construed in the same fashion, e.g., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements).

What is claimed is:

1. A light fixture configured to control angular divergence of emission, the light fixture comprising:
a housing;
an array of light emitting elements disposed in the housing and configured to emit light;
an optical element coupled to the housing and configured to output the light emitted by the array outside of the housing; and
circuitry configured to:
generate a signal representing selection of a mode from among first, second, and third modes; and
control the array of light emitting elements based on the signal such that the light, upon being output outside the housing, has:
a first beam angle when the first mode is selected,
a second beam angle when the second mode is selected, the second beam angle being greater than the first beam angle, and
a third beam angle when the third mode is selected, the third beam angle being greater than the second beam angle,
wherein controlling the array comprises:
causing a first group of light emitting elements to emit the light when the first mode is selected;
causing a second group of light emitting elements to emit the light when the second mode is selected; and
causing a third group of light emitting elements to emit the light when the third mode is selected.

2. The light fixture of claim 1, wherein the light emitting elements of the first group define a first substantially circular arrangement.

3. The light fixture of claim 2, wherein the light emitting elements of the second group define a second substantially circular arrangement encompassing the first substantially circular arrangement.

4. The light fixture of claim 3, wherein the light emitting elements of the third group define a third substantially circular arrangement encompassing the second substantially circular arrangement.

5. The light fixture of claim 1, wherein the first group of light emitting elements is a subset of the second group of light emitting elements.

6. The light fixture of claim 5, wherein the second group of light emitting elements is a subset of the third group of light emitting elements.

7. A light fixture, comprising:
a housing;
an array of light emitting elements disposed in the housing;
circuitry, configured to:
generate a signal representing selection of a mode among a plurality of selectable modes; and
control the array of light emitting elements based on the signal, wherein:
in at least some modes of the plurality of selectable modes, the circuitry causes a different group of light emitting elements of the array to emit light; and
an optical element coupled to the housing, wherein the optical element is configured to output the light emitted by the array of light emitting elements outside the housing.

8. The light fixture of claim 7, wherein:
the plurality of selectable modes comprises at least a first mode and a second mode,
the circuitry is configured to:
control a first group of light emitting elements to emit the light in response to generation of the signal as representing the selection of the first mode, and
control a second group of light emitting elements to emit the light in response to generation of the signal as representing the selection of the second mode, and
the second group comprises more light emitting elements than the first group.

9. The light fixture of claim 8, wherein the first group is a subset of the second group.

10. The light fixture of claim 9, wherein the light emitting elements that are included in the second group and are excluded from the first group encircle the light emitting elements that are included in the first group.

11. The light fixture of claim 8, wherein:
the plurality of selectable modes further comprises a third mode,
the circuitry is further configured to:
control a third group of light emitting elements to emit the light in response to generation of the signal as representing the selection of the third mode, and
the third group comprises more light emitting elements than the second group.

12. The light fixture of claim 8, wherein:
the optical element is configured such that the light emitted by the array of light emitting elements has, upon being output outside the housing:
a first beam angle when the first mode is selected, and
a second beam angle when the second mode is selected,
wherein the second beam angle is greater than the first beam angle.

13. The light fixture of claim 8, wherein the array comprises:
a first plurality of light emitting elements electrically connected in series; and
a second plurality of light emitting elements electrically connected in series,
wherein:
the first group comprises the first plurality of light emitting elements, and
the second group comprises the first plurality of light emitting elements and the second plurality of light emitting elements.

14. The light fixture of claim 7, wherein the optical element comprises:
a reflective portion configured to reflect the light emitted by the array; and
a refractive portion configured to output the reflected light outside the housing.

15. The light fixture of claim 14, wherein the array is disposed approximately at a distance from the refractive portion corresponding to a focal length of the refractive portion.

16. The light fixture of claim 14, wherein:
the optical element further comprises a cavity opposite the refractive portion, and
the array is at least partially aligned with the cavity.

17. A light fixture, comprising:
a housing;
an array of light emitting elements disposed in the housing, the array comprising:
a first plurality of light emitting elements electrically coupled in series with one another; and
a second plurality of light emitting elements electrically coupled in series with one another;
one or more switches, disposed in the housing, configured to cause the array to emit light at least in part by:
in a first state, causing current flow through the first plurality of light emitting elements and blocking current flow through the second plurality of light emitting elements, and
in a second state, causing current flow through the first plurality of light emitting elements and the second plurality of light emitting elements; and
an optical element coupled to in the housing, wherein the optical element is configured to output the light emitted by the array of light emitting elements outside the housing.

18. The light fixture of claim 17, further comprising:
a third plurality of light emitting elements electrically connected in series with one another,
wherein the one or more switches are further configured to cause the array to emit light at least in part by:
in a third state, causing current flow through the first plurality of light emitting elements, the second plurality of light emitting elements and the third plurality of light emitting elements.

19. The light fixture of claim 18, wherein the switches are further configured to:
in the first state, block current flow through the third plurality of light emitting elements, and
in the second state, block current flow through the third plurality of light emitting elements.

20. The light fixture of claim 17, wherein the optical element is configured to:
output the light emitted by the array with a first beam angle when the one or more switches are in the first state; and
output the light emitted by the array with a second beam angle when the one or more switches are in the second state, wherein the second beam angle is greater than the first beam angle.
